(19) United States
(12) Patent Application Publication
(10) Pub. No.: US 2024/0411330 A1
(43) Pub. Date: Dec. 12, 2024

(54) GROUND REFERENCED BANDGAP CIRCUIT IN A NEGATIVELY BIASED SUBSTRATE CMOS INTEGRATED CIRCUIT

(71) Applicant: Western Digital Technologies, Inc., San Jose, CA (US)

(72) Inventor: Zabih Toosky, San Marcos, CA (US)

(21) Appl. No.: 18/447,562

(22) Filed: Aug. 10, 2023

Related U.S. Application Data
(60) Provisional application No. 63/507,643, filed on Jun. 12, 2023.

(51) Int. Cl. G05F 1/46; G05F 1/575; G05F 3/26

(52) U.S. Cl. CPC G05F 1/468; G05F 1/575; G05F 3/267

(57) ABSTRACT

A bandgap reference circuit is disclosed. A current generator is referenced to a first potential and is configured to generate a first current having negative and positive temperature-dependent voltage components. A first current mirror is referenced to the first potential and is configured to receive the first current from the current generator and to generate a second current equal to the first current. A second current mirror is referenced to a second potential and is configured to receive the second current from the first current mirror and to generate a third current equal to the second current. A reference voltage generator is referenced to a third potential and is configured to receive the third current from the second current mirror and to generate a reference voltage that is referenced to the third potential.

### CLAIM OF PRIORITY UNDER 35 U.S.C. 4120

The present Application for Patent claims priority to Provisional Application No. 63/507,643 entitled “GROUND REFERENCED BANDGAP CIRCUIT IN A NEGATIVELY BIASED SUBSTRATE CMOS INTEGRATED CIRCUIT” filed Jun. 12, 2023, and assigned to the assignee hereof and hereby expressly incorporated by reference herein.

### BACKGROUND

Bandgap reference circuits are widely used in integrated circuit (IC) design to generate a precise reference voltage. The term “bandgap” refers to the energy gap between the valence and conduction bands in semiconductors, which is nearly constant over a wide range of temperatures. A bandgap reference circuit produces a constant reference voltage regardless of temperature changes or power supply variations. The reference voltage is typically around 1.25V, approximately equal to the bandgap voltage of silicon.

A bandgap reference circuit typically generates the reference voltage by combining two voltage components that have opposite or inverse temperature coefficients, with the result being a stable reference voltage that is relatively immune to temperature variations. Bipolar junction transistors (BJTs) are well suited to this purpose because of their inherent temperature-dependent properties. In particular, the base-emitter voltage of a BJT decreases as temperature increases (a negative temperature coefficient), whereas the voltage difference between the base-emitter voltages of two BJTs operating at different current levels or densities increases as temperature increases (a positive temperature coefficient). By combining these two voltage components, the positive temperature coefficient voltage component cancels out the negative temperature coefficient component, resulting in net reference voltage that is essentially independent of temperature.

Bandgap reference circuits are commonly used in many types of electronics, such as power supplies and analog-to-digital converters, where a stable reference voltage is needed.

Bandgap reference circuits are often configured ICs fabricated on a bulk silicon substrate using complementary metal-oxide-semiconductor (CMOS) processes. In a bulk CMOS process, both N-channel (NMOS) and P-channel (PMOS) transistors are formed on the same silicon substrate by selectively doping regions of the substrate with impurities to create N-type and P-type regions. Bandgap reference circuits in bulk CMOS processes are often designed using BJTs because of their temperature-dependent properties discussed above. In particular, bandgap reference circuits in bulk CMOS processes are generally designed using vertical PNP transistors. A PNP transistor is a type of BJT with an emitter made of P-type material, a base made of N-type material, and a collector made of P-type material. Vertical PNP devices are used because they share the same diffusion layers with the NMOS and PMOS transistors in the CMOS process, leading to a more compact layout. In addition, lateral-type devices are not available in a CMOS process.

The collector of a vertical PNP device is conventionally formed by the P-type substrate of the IC, thus, the collector is always at the substrate potential. A bandgap reference circuit using such an architecture produces a reference voltage that is referenced to the substrate potential. This works well when the substrate is at ground potential, in other words, when the substrate is biased at 0 volts. In many applications, however, the substrate is biased at a negative potential. In disk drive ICs, for example, a negative substrate bias may be used for electrostatic discharge protection, to enhance signal quality, to prevent write head saturation, to improve the signal-to-noise ratio, and to generate other required voltages within the system. When a negative substrate bias potential or some other non-ground potential is used in an IC and a ground referenced bandgap voltage is still desired, a new approach is needed to reference the bandgap voltage to ground rather than the negative substrate bias potential.

The description provided in this background section should not be assumed to be prior art merely because it is mentioned in this background section. The background section may include information that describes one or more aspects of this disclosure.

### SUMMARY

The following is a summary of one or more aspects or embodiments of this disclosure. It does not necessarily provide an extensive overview of all contemplated aspects or embodiments, identify all or any key elements relating to all contemplated aspects or embodiments, or delineate the scope associated with any aspect or embodiment. The sole purpose of this summary is to present certain concepts relating to one or more aspects or embodiments disclosed herein in a simplified form preceding the detailed description.

One aspect of this disclosure is a bandgap reference circuit comprising: a current generator referenced to a first potential and configured to generate a first current i3 having a negative temperature-dependent voltage component and a positive temperature-dependent voltage component; a first current mirror referenced to the first potential and configured to receive the first current i3 from the current generator and to generate a second current i5 equal to the first current i3; a second current mirror referenced to a second potential and configured to receive the second current i5 from the first current mirror and to generate a third current i7 equal to the second current i5; and a reference voltage generator referenced to a third potential and configured to receive the third current i7 from the second current mirror and to generate a reference voltage Vref that is referenced to the third potential.

In some implementations, the first potential is a negative bias potential of a substrate of an integrated circuit on which the bandgap voltage reference circuit is formed; the second potential is a positive supply potential; and the third potential is ground.

In some implementations, the current generator comprises: an operational amplifier having a non-inverting input, an inverting input, and an output; a first PMOS transistor having its source coupled to the third potential, its gate coupled to the output of the operational amplifier, and its drain coupled to the inverting input of the operational amplifier; a second PMOS transistor having its source coupled to the third potential, its gate coupled to the output of the operational amplifier, and its drain coupled to the non-inverting input of the operational amplifier; a third PMOS transistor having its source coupled to the third potential, its gate coupled to the output of the operational amplifier; and its drain coupled to the first current mirror; a first resistor R0 coupled between the drain of the first PMOS transistor and the first potential; a second resistor R1 coupled between the drain of the second PMOS transistor and the first potential; a first PNP BJT having its emitter coupled to the drain of the first PMOS transistor, and its base and collector coupled to the first potential; a second PNP BJT having its emitter coupled to a third resistor R2, and its base and collector coupled to the first potential; the third resistor R2 being coupled between the drain of the second PMOS transistor and the emitter of the second PNP BJT.

In some implementations, the operational amplifier forces a drain voltage Va of the first PMOS transistor to be equal to a drain voltage Vb of the second PMOS transistor.

In some implementations, a current i1 flows through the first PMOS transistor; a current i2 flows through the second PMOS transistor; the first current i3 flows through the third PMOS transistor; and the currents i1, i2, and i3 are equal due to gate-source voltages of the first, second, and third PMOS transistors being equal.

In some implementations, where Vbe is a base-emitter voltage of the first PNP BJT and AVbe is a difference between Vbe and a base-emitter voltage of the second PNP BJT, the first current i3 is characterized by

$${i}_{3} = \frac{{V}_{be}}{{R}_{1}} + \frac{Δ {V}_{be}}{{R}_{2}} .$$

In some implementations, the first current mirror comprises a first NMOS transistor having its source coupled to the first potential, and its drain coupled to its gate and to the drain of the third PMOS transistor; and a second NMOS transistor having its source coupled to the first potential, its gate tied to the gate of the first NMOS transistor, and its drain coupled to the second current mirror. The first current i3 flows from the third PMOS transistor to the first NMOS transistor, and the second current i5 generated by the first current mirror flows from the second NMOS transistor to the second current mirror.

In some implementations, the second current mirror comprises a fourth PMOS transistor having its source coupled to the second potential, and its drain coupled to its gate and to the drain of the second NMOS transistor; and a fifth PMOS transistor having its source coupled to the second potential, its gate tied to the gate of the fourth PMOS transistor, and its drain coupled to the reference voltage generator. The second current i5 flows from the second NMOS transistor to the fourth PMOS transistor, and the third current i7 generated by the second current mirror flows from the fifth PMOS transistor to the reference voltage generator.

In some implementations, where the reference voltage generator comprises a fourth resistor R3 coupled between the drain of the fifth PMOS transistor and the third potential, the reference voltage Vref referenced to the third potential is generated by applying the third current i7 across the fourth resistor R3.

In some implementations, the reference voltage Vref is characterized by

$${V}_{ref} = ( \frac{{R}_{3}}{{R}_{1}} ) ( {V}_{be} ) + ( \frac{{R}_{3}}{{R}_{2}} ) ( Δ {V}_{be} ) .$$

In some implementations, the bandgap reference circuit is implemented in a hard disk drive.

Another aspect of this disclosure is an integrated circuit comprising: an operational amplifier; first, second and third PMOS transistors, each with their sources grounded and their gates coupled to an output of the operational amplifier, wherein the first PMOS transistor has its drain coupled to an inverting input of the operational amplifier and the second PMOS transistor has its drain coupled to a non-inverting input of the operational amplifier; first and second resistors R0 and R1, equal in resistance, coupling the drains of the first and second PMOS transistors to a negatively biased substrate; first and second PNP BJTs, each with their bases and collectors coupled to the negatively biased substrate, wherein the emitter of the first PNP BJT is coupled to the drain of the first PMOS transistor; a third resistor R2 coupled between the emitter of the second PNP BJT and the drain of the second PMOS transistor; first and second NMOS transistors having their sources coupled to the negatively biased substrate and their gates tied together, wherein the drain of the first NMOS transistor is coupled to the drain of the third PMOS transistor and to the tied gates of the first and second NMOS transistors; fourth and fifth PMOS transistors having their sources coupled to a positive supply potential and their gates tied together, wherein the drain of the fourth PMOS transistor is coupled to the drain of the second NMOS transistor and to the tied gates of the fourth and fifth PMOS transistors; and a fourth resistor R3 coupled between the drain of the fifth PMOS transistor and ground, such that a current flowing from the fifth PMOS transistor and applied across the fourth resistor R3 generates a reference voltage Vref that is referenced to ground.

A further aspect of this disclosure is a method for generating a reference voltage comprising: generating a first current referenced to a first potential, the first current having a negative temperature-dependent voltage component and a positive temperature-dependent voltage component; generating a second current that is equal to the first current and that is referenced to the first potential; generating a third current that is equal to the second current and that is referenced to a second potential; and generating a reference voltage from the third current that is referenced to a third potential.

These and other aspects are depicted in the accompanying figures and described below and will be further apparent based thereon.

### BRIEF DESCRIPTION OF THE DRAWINGS

Features and advantages of this disclosure will be apparent from the following description and accompanying drawings. The drawings are not necessarily to scale; emphasis instead is placed on illustrating principles of technological concepts. In the drawings, like reference characters may refer to the same parts throughout the different views. The drawings depict only illustrative examples of this disclosure and are not limiting in scope.

FIG. 1 is a conceptual block diagram of a bandgap circuit, according to aspects of this disclosure.

FIG. 2 is a more detailed diagram of the bandgap circuit of FIG. 1, according to aspects of this disclosure.

FIG. 3 is a flow diagram of a method for generating a reference voltage, according to aspects of this disclosure.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The embodiments described below are not intended to limit the invention to the precise form disclosed or to be exhaustive. Rather, the embodiments are presented to provide a description so that others skilled in the art may utilize their teachings. Technology continues to develop, and elements of this disclosure may be improved or enhanced, however, this description inherently discloses elements incorporating technology available at the time of this disclosure.

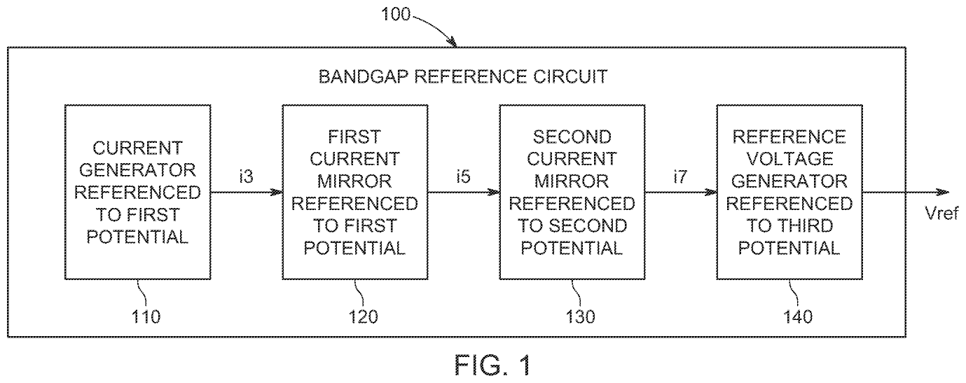

FIG. 1 is a conceptual block diagram of a bandgap reference circuit 100, according to aspects of this disclosure. Bandgap reference circuit 100 comprises current generator 110, first current mirror 120, second current mirror 130, and reference voltage generator 140. Bandgap reference circuit 100 serves to generate a stable reference voltage that is referenced to a particular voltage level such as ground. This disclosure is not limited to any particular electronic component, and bandgap reference circuit 100 may be configured in many types and styles of electronic components in which a stable reference voltage is needed.

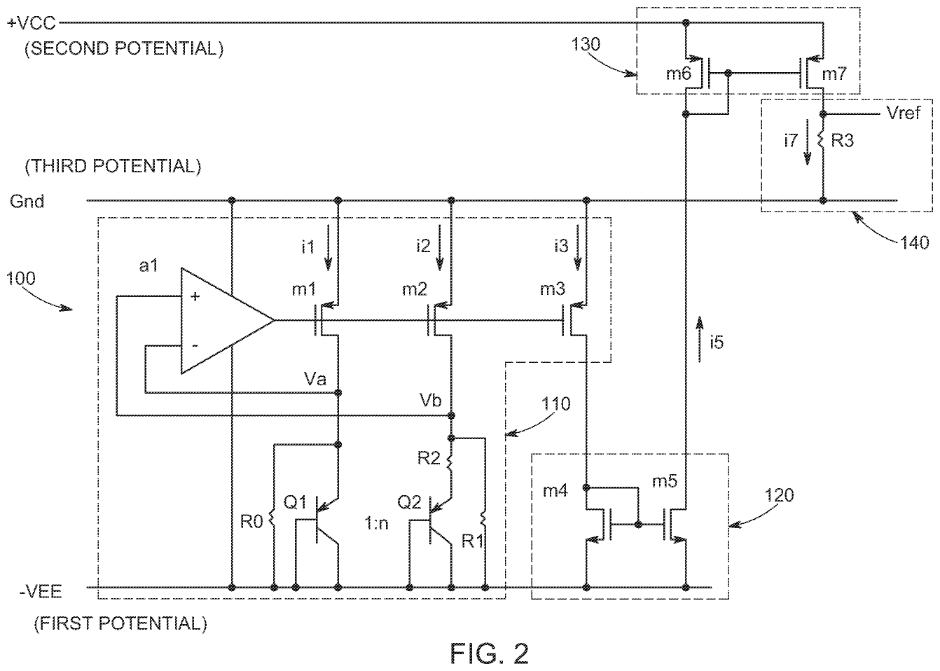

Current generator 110 is referenced to a first potential. In one non-limiting example, the first potential is a negative bias potential of a substrate of an IC on which bandgap reference circuit 100 is formed. While the first potential is depicted in FIG. 2 as −VEE and in one non-limiting example, −VEE is −3V, this value can refer to any negative voltage potential. This is merely one example of a first potential that current generator 110 may be referenced to; current generator 110 may be referenced to other potentials as appropriate to a particular application. Current generator 110 generates a first current i3 that has a negative temperature-dependent voltage component and a positive temperature-dependent voltage component.

First current mirror 120 is also referenced to the first potential and receives first current i3 from current generator 110. As mentioned above, while the first potential is depicted in FIG. 2 as the negative bias potential (−VEE) of the substrate of the IC on which bandgap reference circuit 100 is formed, the first potential may be any other potential as is appropriate to the application. First current mirror 120 generates second current i5 that is equal to first current i3 generated by current generator 110.

Second current mirror 130 is referenced to a second potential and receives second current i5 from first current mirror 120. In one non-limiting example, the second potential is a positive supply potential such as +VCC as depicted in FIG. 2. Common supply potentials, and for non-limiting purposes of illustration, include +5V and +12V. These are merely examples of a second potential that second current mirror 130 may be referenced to; second current mirror 130 may be referenced to other potentials as is appropriate to the application. Second current mirror 130 generates third current i7 that is equal to second current i5 generated by first current mirror 120.

Reference voltage generator 140 is referenced to a third potential and receives third current i7 from second current mirror 130. In one non-limiting example, the third voltage level is ground (0V). This is merely one example of a third potential that reference voltage generator 140 may be referenced to; reference voltage generator 140 may be referenced to other potentials as is appropriate to the application.

FIG. 2 is a more detailed diagram of bandgap reference circuit 100, according to aspects of this disclosure. As can be seen in FIG. 2, current generator 110 of bandgap reference circuit 100 is referenced to a first potential (in one example, a negatively biased substrate) and comprises operational amplifier a1; first, second and third PMOS transistors m1, m2, and m3; first and second PNP bipolar junction transistors Q1 and Q2; and first, second and third resistors R0, R1, and R2. First current mirror 120 is also referenced to the first potential and comprises first and second NMOS transistors m4 and m5. Second current mirror 130 is referenced to a second potential (in one example, a positive supply potential) and comprises fourth and fifth PMOS transistors m6 and m7. Reference voltage generator 140 is referenced to a third potential (in one example, ground) and comprises fourth resistor R3.

In current generator 110, the positive power supply terminal of operational amplifier a1 is coupled to the third potential (in one example, ground), and the negative supply terminal of amplifier a1 is coupled to the first potential (in one example, the negatively biased substrate). The non-inverting input terminal of amplifier a1 is coupled to the drain of second PMOS transistor m2, which is at voltage Vb, and to second and third resistors R1 and R2. The inverting input terminal of amplifier a1 is coupled to the drain of first PMOS transistor m1, which is at voltage Va, to first resistor R0, and to the emitter of first PNP transistor Q1. The output terminal of amplifier a1 is coupled to the gates of first, second and third PMOS transistors m1, m2 and m3.

Current i1 flows into the source of first PMOS transistor m1, which is coupled to the third potential (in one example, ground). The gate of first PMOS transistor m1 is coupled to the output terminal of operational amplifier a1 and to the gates of second and third PMOS transistors m2 and m3. The drain of first PMOS transistor m1, which is at voltage Va, is coupled to the inverting input of amplifier a1, to first resistor R0, and to the emitter of first PNP transistor Q1.

Current i2 flows into the source of second PMOS transistor m2, which is coupled to the third potential (in one example, ground). The gate of second PMOS transistor m2 is coupled to the output terminal of amplifier a1 and to the gates of first and third PMOS transistors m1 and m3. The drain of second PMOS transistor m2, which is at voltage Vb, is coupled to the non-inverting input of operational amplifier a1, and to second and third resistors R1 and R2.

Current i3 (the “first current”) flows into the source of third PMOS transistor m3, which is coupled to the third potential (in one example, ground). The gate of third PMOS transistor m3 is coupled to the output terminal of amplifier a1 and to the gates of first and second PMOS transistors m1 and m2. The drain of third PMOS transistor m3 is coupled to first current mirror 120, in particular, to the drain of first NMOS transistor m4 and to the gates of first and second NMOS transistors m4 and m5.

On end of first resistor R0 is coupled to the drain of first PMOS transistor m1, which is at voltage Va, to the inverting input of amplifier a1, and to the emitter of first PNP transistor Q1. The other end of first resistor R0 is coupled to the first potential (in one example, the negatively biased substrate). As can be seen in FIG. 2, resistor R0 is connected in parallel with first PNP transistor Q1. In one example, first resistor R0 has the same resistance value as second resistor R1, that is, R0=R1.

The emitter of first PNP transistor Q1 is coupled to the drain of first PMOS transistor m1, which is at voltage Va, to the inverting input of amplifier a1, and to one end of first resistor R0. The base and collector of first PNP transistor Q1 are coupled to the first potential (in one example, the negatively biased substrate). The emitter of second PNP transistor Q2 is coupled to third resistor R2. The base and collector of PNP transistor Q2 are coupled to the first potential (in one example, the negatively biased substrate). The ratio of the number of Q1 PNP transistors to the number of Q2 PNP transistors is 1:n. In the example of bandgap reference circuit 100, there is one Q2 transistor and one Q1 transistor. Thus n=1. In another example (not illustrated), if there were 3 Q1 transistors and 27 Q2 transistors, n=9.

One end of second resistor R1 is coupled to the drain of second PMOS transistor m2, which is at voltage Vb, to the non-inverting input of amplifier a1 and to third resistor R2. The other end of second resistor R1 is coupled to the first potential (in one example, the negatively biased substrate). One end of third resistor R2 is coupled to the drain of second PMOS transistor m2, which is at voltage Vb, to the non-inverting input of amplifier a1, and to one end of second resistor R1. The other end of third resistor R2 is coupled to the emitter of second PNP transistor Q2. As can be seen in FIG. 2, third resistor R2 and second PNP transistor Q2 are connected in series, and second resistor R1 is connected in parallel with the series connection of third resistor R2 and second PNP transistor Q2.

In operation of current generator 110, amplifier a1 forces Va (the drain voltage of first PMOS transistor m1) to be equal to Vb (the drain voltage of second PMOS transistor m2). This is known as a “virtual short” or “virtual ground” effect because the differential inputs have the same voltage even though they are not connected. Amplifier a1 amplifies the difference between voltages Va and Vb applied to its input terminals. Amplifier a1 is configured in a negative feedback configuration in which its output is fed back to its inverting input via the gate control of first PMOS transistor m1. At the same time, the non-inverting input of amplifier a1 is coupled to the drain voltage Vb of second PMOS transistor m2.

If voltage Va (the drain voltage of first PMOS transistor m1 and inverting input to amplifier a1) were to rise above voltage Vb (the drain voltage of second PMOS transistor m2 and the non-inverting input to amplifier a1), the output of amplifier a1 would decrease. This reduction in output voltage would reduce the gate voltage of first PMOS transistor m1, causing it to reduce its conduction and thereby bring voltage Va back down towards voltage Vb. Conversely, if voltage Va were to fall below voltage Vb, the output of amplifier a1 would increase. This increase in output voltage would increase the gate voltage of first PMOS transistor m1, causing it to increase its conduction and thereby bring voltage Va back up towards voltage Vb. In this way, amplifier a1 forces Va to be equal to Vb by adjusting its output in response to the difference between Va and Vb, which in turn controls the conduction of first PMOS transistor m1 to balance voltages Va and Vb.

In MOSFETs such as PMOS transistors m1, m2, and m3, the current flowing from the source to the drain (i1, i2, i3) is largely determined by the voltage difference between the gate and the source (the gate-source voltage). In circuit 100, because PMOS transistors m1, m2, and m3 all have their sources connected to the third potential (in one example, ground) and their gates connected to the same voltage (output of amplifier a1), PMOS transistors m1, m2, and m3 will all have the same gate-source voltage. Because PMOS transistors m1, m2, and m3 have the same gate-source voltage (and assuming transistors m1, m2, and m3 are identical and operating in saturation), currents i1, i2, and i3 respectively flowing into PMOS transistors m1, m2, and m3 are equal. That is,

i1=i2=i3.

Both the base and collector of first PNP transistor Q1 are tied to the first potential (in one example, the negatively biased substrate). Thus, voltage Va (the drain voltage of first PMOS transistor m1 and the emitter voltage of first PNP transistor Q1) is equal to the base-emitter voltage of first PNP transistor Q1 (Vbe). As previously described, Vb=Va, so Vb=Va=Vbe. Both the base and collector of second PNP transistor Q2 are also tied to the first potential. Thus, the voltage across third resistor R2 is Vb−Vbe2=Vbe−Vbe2=ΔVbe. Current i2 is equal to the current flowing through third resistor

$$R 2 ( \frac{Δ Vbe}{R 2} )$$

plus the current flowing through second resistor

$$R 1 ( \frac{Vbe}{R 1} ) ,$$

where Vb=Vbe, so

$${i}_{2} = \frac{{V}_{be}}{{R}_{1}} + \frac{Δ {V}_{be}}{{R}_{2}} .$$

Current i3 (the “first current”) is the current flowing from current generator 110 to first current mirror 120. Since i1=i2=i3, current generator 110 is referenced to the first potential (in one example, the negatively biased substrate) and produces an output current i3 (the “first current”) that may be characterized as:

$${i}_{3} = \frac{{V}_{be}}{{R}_{1}} + \frac{Δ {V}_{be}}{{R}_{2}} .$$

The base-emitter voltage (Vbe) of a BJT decreases as temperature increases (a negative temperature coefficient), whereas the voltage difference of the base-emitter voltages of two BJTs operating at different current densities (ΔVbe) increases as temperature increases (a positive temperature coefficient). Thus, the current i3 generated by current generator 110 (the “first current”) may also be characterized as a current that is referenced to the first potential (in one example, the negatively biased substrate) and that has both a negative temperature-dependent voltage component and a positive temperature-dependent voltage component.

In first current mirror 120, the drain of first NMOS transistor m4 is coupled to the drain of third PMOS transistor m3, and therefore also to the current i3 (the “first current”) flowing out from third PMOS transistor m3. The drain of first NMOS transistor m4 is also coupled to the gates of first and second NMOS transistors m4 and m5 (which are tied together). The sources of first and second NMOS transistors m4 and m5 are coupled to the first potential (in one example, the negatively biased substrate). The drain of second NMOS transistor m5 is coupled to second current mirror 130, in particular, to the drain of fourth PMOS transistor m6 and to the gates of fourth and fifth PMOS transistors m6 and m7 (which are tied together).

First and second NMOS transistors m4 and m5 are configured as a current mirror, with their gates tied together and to the drains of third PMOS transistor m3 and first NMOS transistor m4. Current i3 (the “first current”) flowing through third PMOS transistor m3 also flows through first NMOS transistor m4 due to the gate and drain of first NMOS transistor m4 being tied together (forming what's known as a diode-connected transistor). This sets a certain gate-source voltage for first NMOS transistor m4, which is also applied to second NMOS transistor m5 since the gates of NMOS transistors m4 and m5 are tied. Because the gate-source voltages of first and second NMOS transistors m4 and m5 are the same, the drain current i5 in second NMOS transistor m5 (the “second current”) will be equal to the drain current i3 in first NMOS transistor m4 (the “first current”), that is, i5=i3. In sum, the drain current i3 of third PMOS transistor m3 (the “first current”) is mirrored by first and second NMOS transistors m4 and m5, which are referenced to the first potential (in one example, the negatively biased substrate), and then bounced to second current mirror 130, which is referenced to the second potential (in one example, a positive supply potential).

In second current mirror 130, the drain of fourth PMOS transistor m6 is coupled to the drain of second NMOS transistor m5, and therefore also to the current i5 flowing out from second NMOS transistor m5 (the “second current”). The drain of fourth PMOS transistor m6 is also coupled to the gates of fourth and fifth PMOS transistors m6 and m7 (which are tied together). The sources of PMOS transistors m6 and m7 are tied to the second potential (in one example, a positive supply potential). The drain of fifth PMOS transistor m7 is coupled to reference voltage generator 140.

Fourth and fifth PMOS transistors m6 and m7 are configured as a current mirror, with their gates tied together and to the drains of fourth PMOS transistor m6 and second NMOS transistor m5. The current i5 flowing from second NMOS transistor m5 (the “second current”) also flows through fourth PMOS transistor m6 due to the gate and drain of PMOS transistor m6 being tied together (forming what's known as a diode-connected transistor). This sets a certain gate-source voltage for fourth PMOS transistor m6, which is also applied to fifth PMOS transistor m7 since the gates of PMOS transistors m6 and m7 are tied. Because the gate-source voltages of fourth and fifth PMOS transistors m6 and m7 are the same, the drain current i7 in fifth PMOS transistor m7 (the “third current”) will be equal to the drain current i5 in fourth PMOS transistor m6 (the “second current”). Drain current i7 of fifth PMOS transistor m7 is coupled to reference voltage generator 140. Thus, the second current i5, which is equal to the first current i3, is effectively mirrored into fifth PMOS transistor m7 from second NMOS transistor m5 via fourth PMOS transistor m6, or i7=i5=i3.

Reference voltage generator 140 comprises fourth resistor R3 coupled at one end to the output of second current mirror 130 (i.e., to the drain current i7 of fifth PMOS transistor m7) and at its other end to the third potential (in one example, ground). Reference voltage Vref, which is the output of bandgap reference circuit 100, is generated by applying i7 (the “third current”) across fourth resistor R3. Therefore, Vref is referenced to the third potential (in one example, ground) and is equal to i3 multiplied by R3 (i7=i5=i3).

V_{ref}=i₃R₃

$${V}_{ref} = ( \frac{{V}_{be}}{{R}_{1}} + \frac{Δ {V}_{be}}{{R}_{2}} ) ( {R}_{3} ) \\ {V}_{ref} = ( \frac{{R}_{3}}{{R}_{1}} ) ( {V}_{be} ) + ( \frac{{R}_{3}}{{R}_{2}} ) ( Δ {V}_{be} )$$

The above equation is in the form of a familiar bandgap equation, with one term representing a voltage component that decreases with increased temperature and the other term representing a voltage component that increases with increased temperature. Here, Vbe is the base-emitter voltage of PNP bipolar junction transistor Q1 which decreases with an increase in temperature (negative temperature coefficient), and ΔVbe is the difference between the base-emitter voltages of PNP transistors Q1 and Q2, which increases with an increase in temperature (positive temperature coefficient). The combination of these two effects cancels out the temperature-dependent components and allows generation of a reference voltage Vref that is stable and constant over a wide range of temperatures by selecting values for R1, R2 and R3.

In sum, the third current i7 is equal to the first current i3, but whereas the first current i3 flows from the third potential (in one example, ground) to the first potential (in one example, the negatively biased substrate), the third current i7 flows from the second potential (in one example, the positive supply potential) to the third potential (in one example, ground). Stated another way, the third current i7 and the first current i3 are equal, but whereas the third current i7 is referenced to ground, the first current i3 is referenced to the negatively biased substrate potential. Applying current i7 across resistor R3 results in generation of a reference voltage Vref that is referenced to ground.

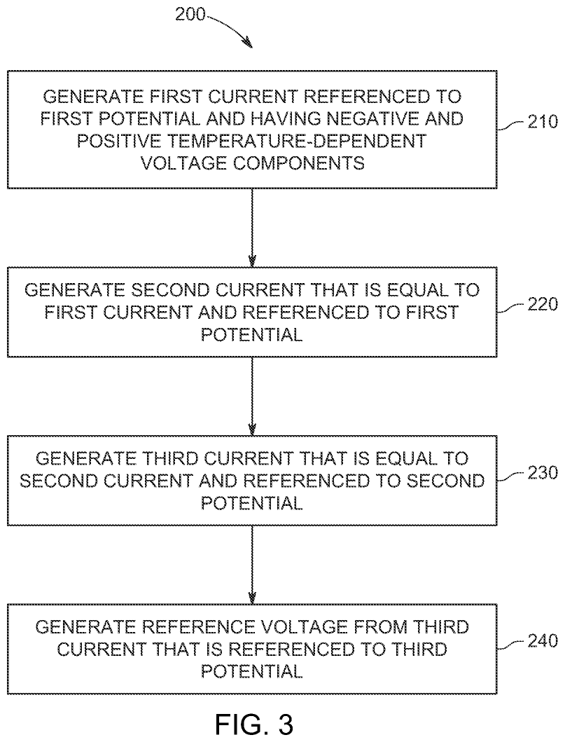

FIG. 3 is a flow diagram of a method 200 for generating a reference voltage, according to aspects of this disclosure. In step 210, a first current (i3=i2=i1) referenced to a first potential (the negatively biased substrate, in one example) is generated. The first current has a negative temperature-dependent voltage component (Vbe/R1) and a positive temperature-dependent voltage component (ΔVbe/R2), such that

$${i}_{3} = \frac{{V}_{be}}{{R}_{1}} + \frac{Δ {V}_{be}}{{R}_{2}} .$$

In one example, the first current i3 is generated by current generator 110 of bandgap reference circuit 100 which comprises operational amplifier a1; first, second, and third PMOS transistors m1, m2, and m3; first and second PNP bipolar junction transistors Q1 and Q2; and first, second, and third resistors R0, R1, and R2 (R1=R0), configured as described above.

In step 220, a second current i5 is generated that is equal to the first current i3 and referenced to the first potential (in one example, the negatively biased substrate). In particular, the first current i3 is coupled to first current mirror 120 that is referenced to the first potential (in one example, the negatively biased substrate) to generate the second current i5. In one example, first current mirror 120 comprises first and second NMOS transistors m4 and m5, configured as described above.

In step 230, a third current i7 is generated that is equal to the second current i5 and referenced to the second potential (in one example, the positive supply potential). In particular, the second current i5 is coupled to second current mirror 130 that is referenced to the second potential (in one example, the positive supply potential) to generate the third current i7. In one example, second current mirror 130 comprises fourth and fifth PMOS transistors m6 and m7, configured as described above.

In step 240, a reference voltage Vref that is referenced to the third potential (in one example, ground) is generated from the third current i7. In one example, reference voltage generator 140 comprises fourth resistor R3 coupled between second current mirror 130 and the third potential (in one example, ground). Applying current i7 across resistor R3 results in generation of a reference voltage Vref that is referenced to the third potential (ground). Therefore, Vref is referenced to the third potential (ground) and is equal to i3 multiplied by R3 (i7=i5=i3):

Vref=i₃R₃

$${V}_{ref} = ( \frac{{V}_{be}}{{R}_{1}} + \frac{Δ {V}_{be}}{{R}_{2}} ) ( {R}_{3} ) \\ {V}_{ref} = ( \frac{{R}_{3}}{{R}_{1}} ) ( {V}_{be} ) + ( \frac{{R}_{3}}{{R}_{2}} ) ( Δ {V}_{be} )$$

As described above, in one example, method 200 may be implemented by suitable control circuitry such as bandgap reference circuit 100, which in turn may be implemented in one or more other electronic components. In other examples, method 200 may be implemented by a microprocessor executing instructions that cause the microprocessor to perform the flow diagram of FIG. 3. The instructions may be stored in any computer-readable medium. In some examples, they may be stored on a non-volatile semiconductor memory device, component, or system external to the microprocessor, or integrated with the microprocessor in an SoC.

The features and methods described above may be used independently of one another or may be combined in various ways. All possible combinations and subcombinations fall within the scope of this disclosure. In addition, certain method steps or features may be omitted in some implementations or combined in a single step or block. Additional features and method steps may be added to the disclosed examples. The example systems and components described herein may be configured differently than described. For example, elements may be added to, removed from, or rearranged compared to the disclosed examples.

While certain embodiments are described herein, these embodiments are presented by way of example only, and do not limit the scope of this disclosure. Nothing in the foregoing description implies that any feature, characteristic, step, module, or block is necessary or indispensable. The methods and systems described herein may be embodied in a variety of other forms. Various omissions, substitutions, and changes in form may be made without departing from the spirit and scope of this disclosure.

This description is provided to enable any person skilled in the relevant fields of art to understand how to make or use the subject matter of this disclosure. Various modifications will be readily apparent to those skilled in the art based on this disclosure, and the principles defined herein may be applied to other examples without departing from the spirit and scope of this disclosure. Thus, this disclosure and the claims that follow are not limited to the embodiments shown herein but are to be accorded the widest scope consistent with the principles and features disclosed herein. Many variations, modifications, additions, and improvements may fall within the scope of the disclosure as defined in the following claims.

What is claimed is:

1. A bandgap reference circuit comprising:
a current generator referenced to a first potential and configured to generate a first current i3 having a negative temperature-dependent voltage component and a positive temperature-dependent voltage component;
a first current mirror referenced to the first potential and configured to receive the first current i3 from the current generator and to generate a second current i5 equal to the first current i3;
a second current mirror referenced to a second potential and configured to receive the second current i5 from the first current mirror and to generate a third current i7 equal to the second current i5; and
a reference voltage generator referenced to a third potential and configured to receive the third current i7 from the second current mirror and to generate a reference voltage Vref that is referenced to the third potential.

2. The bandgap reference circuit of claim 1, wherein
the first potential is a negative bias potential of a substrate of an integrated circuit on which the bandgap voltage reference circuit is formed;
the second potential is a positive supply potential; and
the third potential is ground.

3. The bandgap reference circuit of claim 1, wherein the current generator comprises:
an operational amplifier having a non-inverting input, an inverting input, and an output;
a first PMOS transistor having its source coupled to the third potential, its gate coupled to the output of the operational amplifier, and its drain coupled to the inverting input of the operational amplifier;
a second PMOS transistor having its source coupled to the third potential, its gate coupled to the output of the operational amplifier, and its drain coupled to the non-inverting input of the operational amplifier;
a third PMOS transistor having its source coupled to the third potential, its gate coupled to the output of the operational amplifier; and its drain coupled to the first current mirror;
a first resistor R0 coupled between the drain of the first PMOS transistor and the first potential;
a second resistor R1 coupled between the drain of the second PMOS transistor and the first potential;
a first PNP BJT having its emitter coupled to the drain of the first PMOS transistor, and its base and collector coupled to the first potential;
a second PNP BJT having its emitter coupled to a third resistor R2, and its base and collector coupled to the first potential;
the third resistor R2 being coupled between the drain of the second PMOS transistor and the emitter of the second PNP BJT.

4. The bandgap reference circuit of claim 3, wherein the operational amplifier forces a drain voltage Va of the first PMOS transistor to be equal to a drain voltage Vb of the second PMOS transistor.

5. The bandgap reference circuit of claim 4, wherein
a current i1 flows through the first PMOS transistor;
a current i2 flows through the second PMOS transistor;
the first current i3 flows through the third PMOS transistor; and
the currents i1, i2, and i3 are equal due to gate-source voltages of the first, second, and third PMOS transistors being equal.

6. The bandgap reference circuit of claim 5, wherein
Vbe is a base-emitter voltage of the first PNP BJT;
ΔVbe is a difference between Vbe and a base-emitter voltage of the second PNP BJT; and
the first current i3 is characterized by
$${i}_{3} = \frac{{V}_{be}}{{R}_{1}} + \frac{Δ {V}_{be}}{{R}_{2}} .$$

7. The bandgap reference circuit of claim 6, wherein the first current mirror comprises:
a first NMOS transistor having its source coupled to the first potential, and its drain coupled to its gate and to the drain of the third PMOS transistor; and
a second NMOS transistor having its source coupled to the first potential, its gate tied to the gate of the first NMOS transistor, and its drain coupled to the second current mirror, wherein
the first current i3 flows from the third PMOS transistor to the first NMOS transistor, and
the second current i5 generated by the first current mirror flows from the second NMOS transistor to the second current mirror.

8. The bandgap reference circuit of claim 7, wherein the second current mirror comprises:
a fourth PMOS transistor having its source coupled to the second potential, and its drain coupled to its gate and to the drain of the second NMOS transistor; and
a fifth PMOS transistor having its source coupled to the second potential, its gate tied to the gate of the fourth PMOS transistor, and its drain coupled to the reference voltage generator, wherein
the second current i5 flows from the second NMOS transistor to the fourth PMOS transistor, and
the third current i7 generated by the second current mirror flows from the fifth PMOS transistor to the reference voltage generator.

9. The bandgap reference circuit of claim 8, wherein the reference voltage generator comprises:
a fourth resistor R3 coupled between the drain of the fifth PMOS transistor and the third potential,
wherein the reference voltage Vref referenced to the third potential is generated by applying the third current i7 across the fourth resistor R3.

10. The bandgap reference circuit of claim 9, wherein the reference voltage Vref is characterized by
$${V}_{ref} = ( \frac{{R}_{3}}{{R}_{1}} ) ( {V}_{be} ) + ( \frac{{R}_{3}}{{R}_{2}} ) ( Δ {V}_{be} ) .$$

11. A hard disk drive comprising the bandgap reference circuit of claim 1.

12. An integrated circuit comprising:
an operational amplifier;
first, second and third PMOS transistors, each with their sources grounded and their gates coupled to an output of the operational amplifier, wherein the first PMOS transistor has its drain coupled to an inverting input of the operational amplifier and the second PMOS transistor has its drain coupled to a non-inverting input of the operational amplifier;
first and second resistors R0 and R1, equal in resistance, coupling the drains of the first and second PMOS transistors to a negatively biased substrate;
first and second PNP BJTs, each with their bases and collectors coupled to the negatively biased substrate, wherein an emitter of the first PNP BJT is coupled to the drain of the first PMOS transistor;
a third resistor R2 coupled between the emitter of the second PNP BJT and the drain of the second PMOS transistor;
first and second NMOS transistors having their sources coupled to the negatively biased substrate and their gates tied together, wherein the drain of the first NMOS transistor is coupled to the drain of the third PMOS transistor and to the tied gates of the first and second NMOS transistors;
fourth and fifth PMOS transistors having their sources coupled to a positive supply potential and their gates tied together, wherein the drain of the fourth PMOS transistor is coupled to the drain of the second NMOS transistor and to the tied gates of the fourth and fifth PMOS transistors; and
a fourth resistor R3 coupled between the drain of the fifth PMOS transistor and ground, such that a current flowing from the fifth PMOS transistor and applied across the fourth resistor R3 generates a reference voltage Vref that is referenced to ground.

13. The integrated circuit of claim 12, wherein the reference voltage Vref is characterized by
$${V}_{ref} = ( \frac{{R}_{3}}{{R}_{1}} ) ( {V}_{be} ) + ( \frac{{R}_{3}}{{R}_{2}} ) ( Δ {V}_{be} ) ,$$
wherein Vbe is a base-emitter voltage of the first PNP BJT and ΔVbe is a difference between Vbe and a base-emitter voltage of the second PNP BJT.

14. A hard disk drive comprising the integrated circuit of claim 13.

15. A method for generating a reference voltage comprising:
generating a first current referenced to a first potential, the first current having a negative temperature-dependent voltage component and a positive temperature-dependent voltage component;
generating a second current that is equal to the first current and that is referenced to the first potential;
generating a third current that is equal to the second current and that is referenced to a second potential; and
generating a reference voltage from the third current that is referenced to a third potential.

16. The method of claim 15, wherein
the first potential is a negatively biased substrate of an integrated circuit;
the second potential is a positive supply potential; and
the third potential is ground.

17. The method of claim 16, wherein the step of generating the first current comprises utilizing a current generator comprising:
an operational amplifier;
first, second and third PMOS transistors, each with their sources grounded and their gates coupled to an output of the operational amplifier, wherein the first PMOS transistor has its drain coupled to an inverting input of the operational amplifier and the second PMOS transistor has its drain coupled to a non-inverting input of the operational amplifier;
first and second resistors R0 and R1 respectively coupling the drains of the first and second PMOS transistors to the negatively biased substrate;
first and second PNP BJTs, each with their bases and collectors coupled to the negatively biased substrate, wherein an emitter of the first PNP BJT is coupled to the drain of the first PMOS transistor; and
a third resistor R2 coupled between the emitter of the second PNP BJT and the drain of the second PMOS transistor,
wherein the first current flows through each of the first, second and third PMOS transistors in a direction from ground to the negatively biased substrate.

18. The method of claim 17, wherein the step of generating the second current comprises utilizing a first current mirror comprising:
first and second NMOS transistors having their sources coupled to the negatively biased substrate and their gates tied together, wherein the drain of the first NMOS transistor is coupled to the drain of the third PMOS transistor and to the tied gates of the first and second NMOS transistors,
wherein the second current flows through the second NMOS transistor in a direction from the negatively biased substrate to the positive supply potential.

19. The method of claim 18, wherein the step of generating the third current comprises utilizing a second current mirror comprising:
fourth and fifth PMOS transistors having their sources coupled to the positive supply potential and their gates tied together, wherein the drain of the fourth PMOS transistor is coupled to the drain of the second NMOS transistor and to the tied gates of the fourth and fifth PMOS transistors,
wherein the third current flows through the fifth PMOS transistor in a direction from the positive supply potential to ground.

20. The method of claim 19, wherein the step of generating the reference voltage comprises:
applying the third current across a fourth resistor R3 coupled between the fifth PMOS transistor and ground to generate a reference voltage Vref that is referenced to ground,
wherein the reference voltage Vref is characterized by
$${V}_{ref} = ( \frac{{R}_{3}}{{R}_{1}} ) ( {V}_{be} ) + ( \frac{{R}_{3}}{{R}_{2}} ) ( Δ {V}_{be} ) ,$$
wherein Vbe is a base-emitter voltage of the first PNP BJT and ΔVbe is a difference between Vbe and a base-emitter voltage of the second PNP BJT.
